(19) United States
(12) Patent Application Publication
(10) Pub. No.: US 2020/0175145 A1
(43) Pub. Date: Jun. 4, 2020

(54) BIOMETRIC VERIFICATION SHARED BETWEEN A PROCESSOR AND A SECURE ELEMENT

(71) Applicant: Idemia Identity & Security France, Courbevoie (FR)

(72) Inventors: Aghiles ADJAZ, Courbevoie (FR); Vincent BOUATOU, Courbevoie (FR)

(21) Appl. No.: 16/697,255

(22) Filed: Nov. 27, 2019

(30) Foreign Application Priority Data
Nov. 30, 2018 (FR) 1872107

(51) Int. Cl. G06F 21/32; G06F 21/40

(52) U.S. Cl. CPC G06F 21/32; G06F 21/40

(57) ABSTRACT

The present invention relates to a method for enrolling an individual with a view to processing biometric data of the individual by a processor and by a secure element, comprising the following steps implemented by the processor from a reference biometric data acquired on the individual:
obtaining a logical object calculated from the reference biometric data and from a key, said logical object making it possible to subsequently reconstruct said key from an acquired biometric data if a distance between the reference biometric data and the acquired biometric data is less than a threshold, said logical object being referred to as helper data,
transmitting the key to the secure element.

The processor and the secure element are for example embedded on the same physical medium.

### TECHNICAL FIELD OF THE INVENTION

The invention belongs to the technical field of processing biometric data of individuals in a secure context.

The invention is particularly directed to a method for enrolling an authorized individual and a method for processing biometric data of a candidate individual, as well as an associated device.

### STATE OF THE ART

The biometric authentication of a candidate individual consists of comparing a biometric data acquired on the candidate with a biometric data registered as reference using a comparison function. Based on the result of the comparison, the candidate individual is either authenticated if they correspond to the reference individual that they claim to be or rejected.

Reference biometric data are very sensitive data which it is desirable to protect from malicious external attacks. Hence, it has been proposed to register these data on secure elements, e.g. in a SIM or secure micro-SD chip or in an EMV chip.

A secure element is provided with cryptographic keys and is physically isolated from other components of the electronic device within which it is integrated, guaranteeing a very high level of security.

Several biometric authentication protocols using a microprocessor and an associated secure element are known. These protocols are implemented in, e. g. smart cards.

According to a first known method, the microprocessor carries out the acquisition of the biometric data and its comparison with a reference data stored on the microprocessor. The secure element receives a simple verification result (OK or NOK). Alternatively, the secure element is activated only if the verification is positive.

It is possible to use powerful algorithms for biometric comparison, in particular to take into account the variability of biometric measurements—several acquisitions of the same biometric trait on the individual may lead to different results.

The performance of the current comparisons is made possible by the computing power and memory space of the microprocessors on the market, adapted to such algorithms.

However, if the reference biometric data is stored on a microprocessor, the security level of the stored biometric data is low, in particular if this microprocessor is also capable of connecting to a communication network such as the Internet. An encryption of the reference data and possible intermediate results by cryptographic functions are not always sufficient to prevent an attacker from tracing back the biometric data.

According to a second known method, authentication is shared between the processor and the secure element.

For this second method, the processor manages only the acquisition of the biometric data on the candidate individual and then supplies (preferably in encrypted form) the acquired biometric data to the secure element. The latter, which has a reference biometric database, carries out the comparison.

An important benefit of this protocol is the possibility of avoiding the storage of individuals' biometric data on the microprocessor, which constitutes a much lower security platform than that of the secure element. Additionally, comparisons on an insecure platform are also avoided.

However, standard secure elements, which are commonly found on secure SIM or micro-SD chips or EMV chips, are very limited in computing power and are devoid of software blocks for managing operations related to biometrics. When a biometric function has to be added, it is then necessary to add a biometric algorithm that consumes few resources (CPU, memories) and therefore is not very efficient for comparing the biometric data. For example, a known compromise consists of using a smaller number of minutiae for the biometric comparison, with regard to the comparison that would be carried out on a microprocessor.

Neither of the two methods described above is entirely satisfactory for rapid, secure and reliable biometric authentication of a candidate individual from a database of authorized individuals.

### GENERAL DESCRIPTION OF THE INVENTION

In view of the above, there is a need for a biometric verification method of the identity of an individual using a processor and a secure element, which makes it possible to avoid the storage of a reference biometric data on an insecure platform.

There is also a need for biometric processing whose level of performance, particularly in terms of false positives and false negatives, as well as speed, are improved.

An enrollment of authorized individuals suitable for the subsequent implementation of such authentication is also sought.

The sought enrollment and verification methods are preferably usable with a standard secure element devoid of a software block dedicated to biometrics, and do not require that the secure element has a high computing power or a large memory space.

A first object of the invention therefore relates to a method for enrolling an individual with a view to processing biometric data of the individual, said enrollment method conforming to claim 1.

The enrollment method of the invention carries out a shared storage of the data necessary for biometric processing: the key linked to the individual, which constitutes a comparison data and which requires a very high level of security, is stored on the secure element, while the helper data necessary for a subsequent reconstruction of the key is stored on the processor.

This sharing is satisfactory in terms of the security of the biometric data, to the extent that the helper data alone is not such as to allow knowledge of the reference biometric data without having a reconstruction function.

In addition, the calculation processes necessary for the enrollment are performed by the processor, and the comparison data can be stored on a standard secure element.

An additional advantage is that, even in the case where the communication of the key between the processor and the secure element would be intercepted by an external attacker during the enrollment, the individual's reference biometric data remains secret.

Another additional advantage is that the key can be a very simple digital data, such as a PIN code, requiring little memory space for its storing in the secure element during the enrollment.

The enrollment method defined above may include the following optional and non-limiting characteristics, taken alone or in any of their technically possible combinations:
the processor and the secure element are embedded on a single physical medium. For example, a smart card constitutes an appropriate physical medium to embed the processor and the secure element.
the helper data comprises a result from the exclusive OR operator applied to the reference biometric data and to the key.
the key is independent from the reference biometric data.
the processor is configured to perform a reconstruction function taking as input the helper data and an acquired biometric data, the reconstruction result provided as output by the reconstruction function depending on the distance between the reference biometric data and the acquired biometric data.
the helper data is calculated from an error correcting code associated with a plurality of error correcting code elements separated two by two by a predetermined gap.
during the transmission step, the key is transmitted in encrypted form to the secure element.
the reference biometric data is erased from the memory of the processor at the end of the enrollment method.
the method comprises an additional step of recording the key in a memory of the secure element, in encrypted form.
the reference biometric data is obtained from a biometry pattern, said biometry preferably being a fingerprint or an iris or a face or a voice.

Another object of the invention is a biometric processing method of data from a candidate individual by a processor and by a secure element, the processing following one of the enrollment methods as defined above applied to at least one authorized individual, the processing method comprising the following steps implemented by the processor:

receiving an acquired biometric data;

obtaining a reconstruction result from the acquired biometric data and from a helper data obtained during the enrollment of the authorized individual;

transmitting the reconstruction result to the secure element.

A benefit of the processing method of the invention is that it takes into account the variability of the biometric data acquired on a same individual, the reconstruction result being subjected to less variability than the acquired biometric data.

This method has a high level of security due to the fact that the comparison between the reconstruction result and the data associated with the authorized individual is carried out outside the processor. The data associated with the authorized individual are held only by the secure element and therefore are inviolable.

This method also has a high level of performance, since the reconstruction result is obtained on the processor, which is much less limited in computing power than the secure element. The comparison performed subsequently at the level of the secure element can be very simple, without loss of performance for the overall biometric processing.

The above-mentioned method for processing biometric data may further include the following optional and non-limiting characteristics, taken alone or in any one of their technically possible combinations:
the biometric processing comprises an authentication or an identification of the candidate individual, comprising a step implemented by the secure element of binary comparison between, on the one hand, the reconstruction result and, on the other hand, a key transmitted to the secure element during enrollment.
the binary comparison step is implemented with respect to a plurality of reference biometric data each associated with an authorized individual, or a plurality of keys each associated with an authorized individual.

Another object of the invention is a processor for use in processing biometric data of an individual, comprising computer code instructions making it possible to obtain a reconstruction result from an acquired biometric data and from a helper data as defined above in relation to the enrollment methods, the processor being configured to perform an enrollment method and a method for processing biometric data as defined above.

The invention also relates to an assembly for processing biometric data from an individual, comprising a processor as defined above and comprising a secure element, the processor comprising an interface for communication with the secure element.

### GENERAL DESCRIPTION OF THE FIGURES

Other characteristics, goals, and advantages of the invention will become clear from the following description, which is purely illustrative and non-limiting, accompanied by the attached drawings in which:

FIG. 1 depicts an assembly comprising a smart card and a biometric sensor;

FIG. 2 illustrates the steps of an enrollment method according to an embodiment;

FIG. 3a and FIG. 3b depict the calculation of helper data during an enrollment and the use of said helper data during an authentication, respectively according to a first variant and according to a second variant;

FIG. 4 illustrates the steps of an enrollment method according to an embodiment.

### DETAILED DESCRIPTION OF EMBODIMENTS

The description below relates to an exemplary enrollment of a candidate individual 1 with a view to subsequent authentication, i.e. that the candidate individual claims to have an identity corresponding to that of an authorized individual, of which at least one data has been prerecorded on a secure element of a computer medium. A comparison of the type “1:1” is then carried out, during the authentication between the prerecorded data and the results obtained from a biometric data acquired on the candidate individual, coming from the same type of biometric as that used for the enrollment.

However, it is understood that the invention may be applied, with the same benefits, in the case of an identification. Subsequently, the data acquired on the candidate individual is compared with a plurality of prerecorded data in the secure element, corresponding to M different authorized individuals. The comparison carried out is then of the type “1:M”.

More generally, the invention may be applied to any biometric data processing intended to verify the identity of a candidate individual.

In the following description and in the accompanying drawings, similar elements are designated by the same alphanumeric references.

### Electronic Voting System

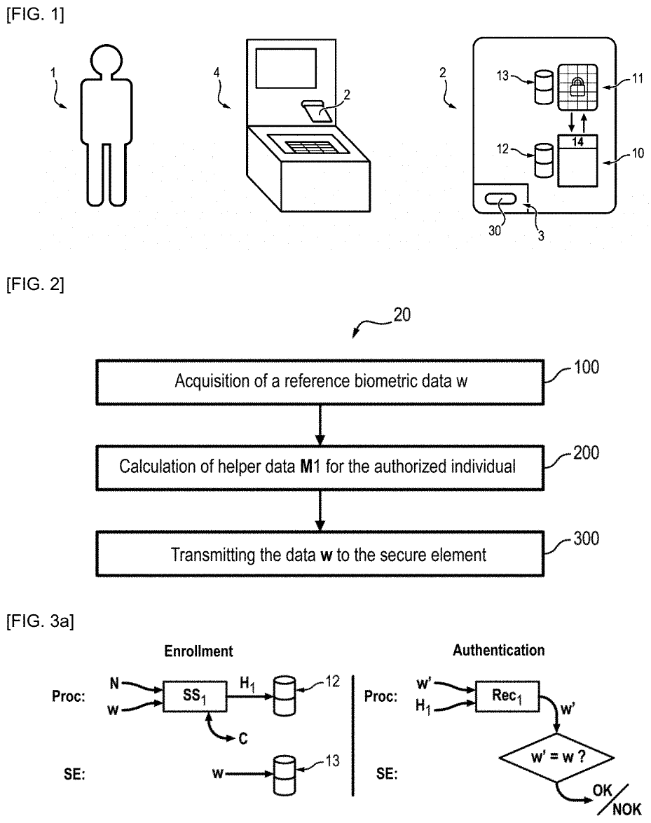

In FIG. 1 an assembly for processing biometric data of a candidate individual 1 with a view to verifying their identity has been depicted.

This assembly comprises a card 2 comprising an electronic chip (hereinafter “smart card”) and a biometric sensor 3. Preferably, the biometric sensor 3 is directly integrated into the smart card 2.

Alternatively, the smart card 2 could be separable from the biometric sensor 3. In this latter variant, the biometric sensor 3 may for example comprise a slot for inserting the card 2. The slot comprises therefore an electronic link to allow data exchange between the card and the sensor.

Referring back to FIG. 1, the smart card 2 comprises a processor 10 and a secure element 11.

The smart card 2 thus constitutes a single physical medium whereon the processor 10 and the secure element 11 are stored.

“Secure element” means a secure material platform configured to carry out inviolable data storage using cryptographic keys. The secure element 11 has its own cryptographic keys, which are preferably distinct from any other eventual keys used by the processor 10.

If the secure element is an electronic chip, this chip is physically separated from the rest of the physical medium, herein from the smart card 2. The electronic chip forming the secure element is in particular separated from the means for calculating and storing data comprised in the processor 10.

Herein, the secure element 11 comprises a memory 13 for storing at least one reference biometric data, or a key, associated with an authorized individual. Any writing of data and any extraction of data from the memory 13 requires encryption/decryption with the cryptographic keys of the secure element.

Such a secure element is easily auditable by a trusted authority, to certify its security.

By way of examples of secure elements, it is possible to use a SIM chip, a secure micro-SD chip, or a bank chip conforming to the EMV standard (initials for “Europay Mastercard Visa”). An EMV chip is specifically configured to perform banking transactions such as debits or credits.

In the example of FIG. 1, the card 2 is a bank payment card and the secure element 11 is an EMV chip. This is advantageous because the number of electronic payment terminals throughout Europe and in many other territories is predominantly adapted for the use of payment cards with EMV chips.

Advantageously, the secured element 11 is a standard secured element, commonly available on the market.

“Standard secure element” means that the secure element 11 (herein the EMV chip) is devoid of an algorithm specific to biometric operations. In particular, the secure element 11 does not comprise a software block dedicated to biometrics. Thus, it is not necessary to provide a secure element of a specific type for biometrics when the card is manufactured. Additionally, by virtue of the enrollment methods and authentication described below, a secure element with a high computing power is not necessary.

The processor 10 is preferably a microprocessor. It comprises a memory 12 for storing data, in particular biometric data and intermediate calculation results. It also has an interface 14 for communication with the secure element 11. The data exchanged on the interface 14 are encrypted.

Preferably, the processor 10 has a higher computing power than that of the secure element 11.

It should be noted that, according to a variant, the smart card 2 can be replaced by any electronic device having a platform forming a secure element, and comprising calculation means separate from the secure element. Said electronic device is preferably a mobile device that can be easily transported, e.g. a USB stick or a mobile terminal, but it can also be a fixed device. If the sensor 3 is external to said electronic device, said electronic device communicates wired or wirelessly with the sensor 3.

The sensor 3, whether integrated or not in the smart card 2, comprises a biometric acquisition area 30; in this example, fingerprints are used as biometrics and the area 30 is a finger positioning area.

Alternatively, any type of biometrics can be used. It is possible to use images of the candidate individual, e.g. face images. In particular, it is possible to extract an iris pattern from an image of the individual 1. It is also possible to use a sound signal derived from the voice of the candidate individual.

The sensor 3 further comprises a communication interface with the card 2 for communicating the biometric data acquired to the card 2.

The assembly of FIG. 1 makes it possible to control access to a service. Herein, the smart card 2 is used on a remote payment terminal 4, adapted to operate with the international EMV standard.

### Enrollment of Authorized Individuals

In FIG. 2 the steps of the enrollment method 20 of authorized individuals according to a first embodiment have been depicted.

The enrollment is intended to acquire and record data from an individual's biometric, with a view to recognizing the same individual in a subsequent biometric authentication attempt. This method can be implemented by the processor 10 of FIG. 1, in conjunction with the sensor 3 and the element 11.

In a step 100, a reference biometric data w is acquired in a certified manner on the individual. “Certified acquisition” means that the acquired data can be reliably associated with the individual. For example, the individual may be asked to provide an official identity document at the time of the certified acquisition.

Herein, a fingerprint pattern is acquired using the sensor 3, then the fingerprint minutiae are extracted. The reference biometric data w is generated as a binary vector.

Alternatively, the reference biometric data w may have been acquired prior to enrollment 20, and the processor retrieves the reference biometric data from a remote database. In this case, the reference biometric data has preferably been stored in the database in a secure manner.

Then, in a step 200, the processor 10 of the card 2 generates helper data. The helper data are also called “helper data” according to current Anglo-Saxon terminology. Preferably, these helper data are calculated by a secure sketch function or “secure sketch”.

The purpose of the helper data stored in the memory of the processor 10 is to be able subsequently to reconstruct, during authentication, a comparison data from a biometric data acquired on the fly, if the distance between the latter data and the reference biometric data w is sufficiently small.

In this respect, the helper data comprise a logical object H1 calculated from the reference biometric data w, representing the distance between the data w and a key. This key is, for example, a number generated randomly according to a method preconfigured in the processor, or a key entered by the user. The key is for example a PIN code.

In a “secure sketch” construction, the helper data comprise a binary vector that represents the Hamming distance between the vector w and said key.

An error correcting code C comprises a plurality of error correcting code elements, called “codewords”, separated two by two by a minimum gap dₘᵢₙ, the gap dₘᵢₙ being obtained as the Hamming distance between the codewords.

Thus, if the Hamming distance between two binary vectors is less than dₘᵢₙ/2, the codeword least distant from each of the two binary vectors is the same.

For a complete mathematical construction of an error correcting code C on a finite alphabet F, reference should be made to section 2.1 of the following document: The best of both worlds: Applying secure sketches to cancelable biometrics, Julien Bringer, Hervé Chabanne, Bruno Kindarji, Science of Computer Programming 74 (2008) 43-51.

At the end of step 200, the helper data (here the logical object H1) are recorded in the memory of the processor.

It should be noted that an external attacker cannot go back to the reference biometric data w from the helper data. An external attacker cannot either go back to the PIN key from the helper data.

Finally, in a step 300, in order to complete the enrollment, a comparison data, provided during the enrollment, is transmitted by the processor 10 to the secure element 11.

The comparison data is a data directly provided to the processor, which is not obtained by a processing performed by the processor.

In this first embodiment, the reference biometric data w is transmitted directly to the secure element 11. The comparison data associated with the enrollment of the authorized individual is therefore the reference biometric data w itself.

Alternatively, the data corresponding to the reconstruction result (herein the data w) is directly acquired by the secure element. The data is then not transmitted by the processor.

In view of the very high level of security of the secure element 11, the data stored in the element 11 is considered inviolable.

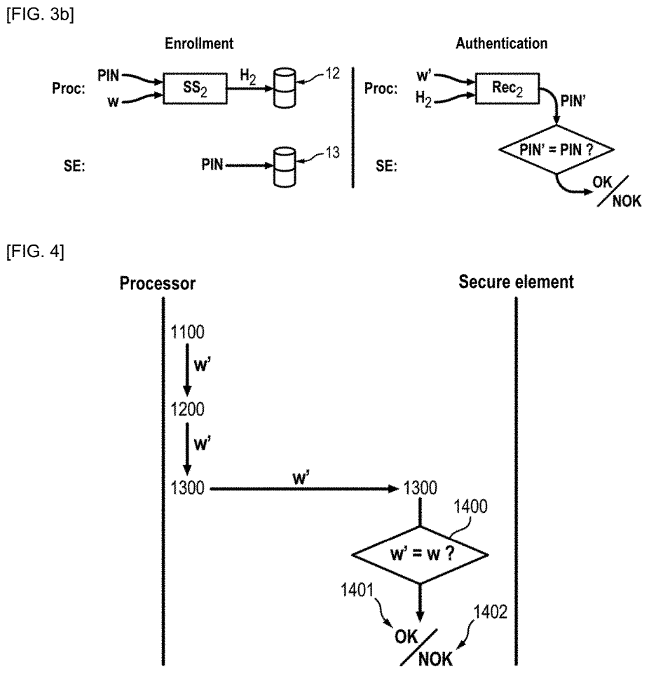

To the left of FIG. 3a, operations carried out during an enrollment according to the embodiment of FIG. 2 have been depicted schematically.

The helper data H₁ are here calculated using a secure sketch function SS1 loaded into the processor. The function SS₁ is associated with an error correcting code C. The function SS₁ takes as input, in the step 200 above, the data w:

H₁=SS₁(w)=w XOR N,

where N is a key (herein a random vector of the same dimension as the data w), and XOR is the exclusive OR operator.

The processor then stores the helper data H₁ and transmits the reference biometric data w to the secure element, preferably in encrypted form (using, for example, a hash function).

Very advantageously, the data w is not recorded in the processor 10 at the end of enrollment.

To the left of FIG. 3b, operations of an enrollment according to a second embodiment have been depicted schematically.

In this second embodiment, the helper data, herein denoted H₂, are calculated from the reference data w, and using a PIN key. Herein the PIN key is a vector of the same dimension as the data w.

The PIN key is, for example, a key entered by the authorized individual during their enrollment, or a randomly selected key.

Preferably, a numerical value of the PIN key is independent from a numerical value of the reference biometric data w. This condition is typically satisfied if the PIN key is entered by the user or randomly generated by the processor.

This PIN key is intended to remain secret, as is the data w.

Advantageously, the helper data H₂ are calculated using a secure sketch function SS₂ loaded into the processor, which is associated with an error correcting code C and which takes as input the data w and the PIN key:

H₂=SS₂(w,PIN)=w XOR PIN,

where XOR is the exclusive OR operator.

The processor then stores the helper data H₂ and transmits the PIN to the secure element, preferably in encrypted form (using, for example, a hash function). The comparison data transmitted to the secure element is therefore the PIN key herein.

An enrollment according to this second embodiment does not require the transmission, to the secure element, of the reference biometric data w of the authorized individual.

The enrollment according to this second embodiment therefore is advantageous because even if an external attacker compromises the communication interface 14 between the processor 10 and the secure element 11 during the enrollment, this attacker cannot obtain the data w.

Very advantageously, neither the data w nor the PIN key is recorded in the processor 10 at the end of the enrollment.

It should be noted that enrollment according to any one of the above embodiments, or according to both cumulative embodiments, can be used to enroll a single individual or a plurality of authorized individuals. A plurality of helper data associated with different individuals is then stored in the processor, and a plurality of biometric data and/or keys associated with those individuals are recorded in the secure element.

### Authentication of Candidate Individuals

FIG. 4 illustrates a method for processing biometric data of a candidate individual, according to a first embodiment. Herein, biometric processing is an authentication aimed at establishing whether the identity of the candidate corresponds to an authorized and previously enrolled individual.

Authentication is implemented for example by an assembly as described above with reference to FIG. 1.

Preferably, the authorized individual has been enrolled according to one of the enrollment methods described above.

Before authentication, the card 2 comprises, in the memory of the secure element 11, a comparison data associated with the authorized individual, entered during enrollment. The comparison data herein is a reference biometric data w of the authorized individual, and/or a PIN key associated with the authorized individual. The authentication comprises a comparison between a reconstruction result, obtained from biometric data acquired on the fly on the candidate, and said comparison data.

In a step 1100, a biometric data w′ is acquired on the candidate individual. The biometric data w′ acquired must correspond to the type of biometry used for enrollment. Herein, the data w′ comes from a fingerprint pattern, and is a binary vector.

Alternatively, biometric data w′ may be acquired prior to authentication.

In a step 1200, from the acquired data w′, and from the helper data (e.g. H₁ or H₂) previously stored in the processor 10, a reconstruction result is obtained.

The reconstruction result is calculated using a reconstruction function taking as input the data w′, the reconstruction function being loaded into the memory of the processor. This function is such that, if the distance between the data w′ and the reference data w coming from the authorized individual is less than a predetermined threshold (herein dₘᵢₙ/2), then the reconstruction result corresponds to the comparison data recorded during the enrollment.

The reconstruction result, provided as output by the reconstruction function, therefore depends on the distance between the reference biometric data w and the acquired data w′.

The reconstruction result from step 1200 is transmitted to the secure element in a step 1300, preferably in encrypted form.

Then, in a step 1400, a binary comparison is performed between the reconstruction result and the comparison data recorded in the secure element in relation to the authorized individual.

If the reconstruction result (herein w″) is identical to the recorded data (herein the reference biometric data w), then a positive determination 1401 is obtained.

If the reconstruction result is not identical to the recorded data, then a negative determination 1402 is obtained.

Optionally, access to a service, such as an electronic vote or a remote payment, may be granted or denied depending on the result of the authentication.

In the method illustrated in FIG. 4, the authentication is carried out according to a first embodiment depicted to the right of FIG. 3a.

This first embodiment for authentication may be implemented following enrollment according to the embodiment depicted in FIG. 3a.

In this embodiment, a reconstruction function Rec₁ is performed in step 1200. The function Rec₁ takes as input the acquired data w′ and the helper data H₁ as described above.

Herein, an intermediate result B₁ is obtained by the following equation:

B₁=H₁ XOR w′

Then, the error correcting code C is applied to this intermediate result to obtain a result B₁*.

If the distance between w and w′ is less than dₘᵢₙ/2, then, by constructing the error correcting code C, N is obtained as output of the error correcting code, with N being the random number that had been used to generate the data H₁.

Finally, the reconstruction result is obtained as follows:

w″=Rec₁(w′)=H₁ XOR B₁*

If the distance from w to w′ is less than dₘᵢₙ/2 the following is obtained:

w″=w.

In step 1300, the reconstruction result w″ is transmitted to the secure element, which performs a binary comparison in step 1400 between w″ and w and determines whether the biometric authentication is valid.

In FIG. 3b to the right a second embodiment for authentication, which can be implemented following an enrollment using a PIN key, such as the enrollment of FIG. 3b, has been depicted.

In this embodiment, in step 1200, a function Rec₂ takes as input the acquired data w′ and the helper data H₂ as described above.

Herein, an intermediate result B₂ is obtained by the following equation:

B₂=H₂ XOR w′

The error correcting code C is then applied to the intermediate result B₂, in order to obtain a reconstruction result PIN′.

If the distance between w and w′ is less than dₘᵢₙ/2, then, by constructing the error correcting code C, the PIN key is obtained as an output of the error correcting code:

PIN′=Rec₂(w)=PIN.

The result as an output of the error correcting code is transmitted to the secure element 11 in step 1300. In the case where the distance between w and w′ is less than dₘᵢₙ/2, the result of the comparison 1400 within the secured element is positive.

It should be noted that, in this second embodiment, it is possible to replace steps 1100 to 1300, comprising the acquisition of a biometric data, by simply entering a key (e.g. a PIN code) on an equipment such as a payment terminal.

If the key entered corresponds to the key prerecorded in the secure element, then the result of the authentication of the candidate individual is positive.

Enrollment using a PIN code therefore has the benefit of subsequently allowing authentication either by biometric data acquisition or by manual input of the PIN code.

In either of the embodiments described above for authentication, the secure element is used solely to carry out a binary comparison based on the reconstruction result.

Thus, it is not necessary to have a secure element integrating a software block dedicated to biometrics with a high computing power. A standard secure element can be used.

Moreover, the biometric reference data of the authorized individual is never used by the processor. Therefore, an external attacker cannot go back to the biometric data of the authorized individual.

1. An enrollment method of an individual for processing biometric data of the individual by a processor and by a secure element, comprising the following steps implemented by the processor from a reference biometric data (w) acquired on the individual:
obtaining (200) a logical object calculated from the reference biometric data (w) and from a key (PIN), said object making it possible to subsequently reconstruct said key (PIN) from an acquired biometric data (w′) if a distance between the reference biometric data (w) and the acquired biometric data (w′) is less than a threshold, said logical object being referred to as helper data (H1),
transmitting (300) the key (PIN) to the secure element.

2. The enrollment method according to claim 1, wherein the processor (10) and the secure element (11) are embedded on a single physical medium (2).

3. The method according to claim 1, wherein the helper data (H1) comprises a result from the exclusive OR operator applied to the reference biometric data (w) and to the key (PIN).

4. The enrollment method according to claim 1, wherein the key (PIN) is independent from the reference biometric data (w).

5. The enrollment method according to claim 1, wherein the processor is configured to perform a reconstruction function (Rec₁) taking as input the helper data (H1) and an acquired biometric data (w′), wherein a reconstruction result provided as output by the reconstruction function (Rec₁) depends on the distance between the reference biometric data (w) and the acquired biometric data (w′).

6. The enrollment method according to claim 1, wherein the helper data (H1) is calculated from an error correcting code (C) associated with a plurality of error correcting code elements separated two by two by a predetermined gap.

7. The enrollment method according to claim 1, wherein, during the transmission step (300), the key (PIN) is transmitted in encrypted form to the secure element.

8. The enrollment method according to claim 1, wherein the reference biometric data (w) is erased from the memory of the processor at the end of the enrollment method.

9. The enrollment method according to claim 1 comprising an additional step of recording the key in a memory of the secure element, in encrypted form.

10. The enrollment method according to claim 1, wherein the reference biometric data (w) is obtained from a biometry pattern, said biometry preferably being a fingerprint or an iris or a face or a voice.

11. A biometric processing method of data from a candidate individual by a processor and by a secure element, the processing following an enrollment of at least one authorized individual according to an enrollment method according to claim 1, the processing method comprising the following steps implemented by the processor:
receiving (1100) an acquired biometric data (w′);
obtaining (1200) a reconstruction result from the acquired biometric data (w′) and from a helper data (H1) obtained during the enrollment of the authorized individual;
transmitting (1300) the reconstruction result to the secure element.

12. The biometric processing method according to claim 11, wherein the biometric processing comprises an authentication or an identification of the candidate individual, comprising a step implemented by the secure element of binary comparison (1400) between, on the one hand, the reconstruction result and, on the other hand, a key (PIN) transmitted to the secure element during enrollment.

13. The biometric processing method according to claim 12, wherein the binary comparison step (1400) is implemented with respect to a plurality of keys (PIN) each associated with an authorized individual.

14. A processor (10) for use in processing biometric data from an individual, comprising computer code instructions for making it possible to obtain a reconstruction result from an acquired biometric data and from the helper data, the processor being configured to perform the enrollment method and to perform a biometric processing method according to claim 11.

15. An assembly for processing biometric data from an individual comprising a processor (10) according to claim 14 and further comprising a secure element (11), the processor comprising an interface (14) for communication with the secure element.
